(19) United States
(12) Patent Application Publication
(10) Pub. No.: US 2014/0033020 A1
(43) Pub. Date: Jan. 30, 2014

(54) INFORMATION PROCESSING APPARATUS AND METHOD OF CONTENTS MANAGING

(71) Applicant: FUJITSU LIMITED, Kawasaki-shi (JP)

(72) Inventor: Kazuo TOMONO, Kawasaki (JP)

(73) Assignee: FUJITSU LIMITED, Kawasaki-shi (JP)

(21) Appl. No.: 13/895,161

(22) Filed: May 15, 2013

(30) Foreign Application Priority Data
Jul. 30, 2012 (JP) 2012-168969

(51) Int. Cl. G06F 17/22

(52) U.S. Cl. CPC G06F 17/2247
USPC 715/234

(57) ABSTRACT

An information processing apparatus includes a contents storage unit that stores contents, the contents being data for conducting a display on a web site, a registration receiving unit that receives registration contents, a determining unit that determines whether the registration contents received by the registration receiving unit matches storing contents previously stored in the contents storage unit, and a registration processing unit that, when the registration contents received by the registration receiving unit match the storing contents previously stored in the contents storage unit, stores either one of the registration contents or the storing contents and erases another contents.

### CROSS-REFERENCE TO RELATED APPLICATION

This application is based upon and claims the benefit of priority of the prior Japanese Patent Application No. 2012-168969, filed on Jul. 30, 2012, the entire contents of which are incorporated herein by reference.

### FIELD

The embodiments discussed herein relate to an information processing apparatus and a method of contents managing.

### BACKGROUND

Recently, the supply and dissemination of information from web sites and the like on the World Wide Web is increasing. Data based on information such as text and images supplied and/or disseminated on a web site are called web contents.

Users of the web site read the web site for obtaining various types of information. Consequently, the web contents are desirably continuously updated to be able to provide the latest information to the users.

Accordingly, a conventional technique has been suggested as a technique for managing a web site by conducting hierarchical management of the web contents to display web contents rankings, frequencies of accesses along web contents paths, and/or link statuses of the web contents. There is also a conventional technique for providing a tracking server on a network to obtain access path information to the web contents.

However, it is possible that old contents still remain when continuously renewing web contents. When the old contents remain in this way, there is a risk that the old contents may accumulate in a server running the web site due to the operation of the web contents. Server resources such as hard disk space and the like are consumed due to the accumulation of the old contents in the server. This may lead to a reduction in server responsiveness.

When new web contents are added without considering the entire configuration, the access pages to each web page may become complicated and usability of the web site may be reduced.

In order to avoid such problems, a web contents manager is expected to review the entire web site configuration to find and erase old contents when adding web contents, thus making work for the web contents manager more tedious.

In the case of the conventional technique of conducting hierarchical management of the contents, the manager configures the web site while considering the hierarchy to conduct hierarchical management using uniform resource locators (URLs). As a result, it is difficult to make the web contents manager's work more efficient. Moreover, a large amount of server resources are used for analyzing the web site for accumulating logs in a normal format. Thus the web site analysis takes a long time and it is difficult to make the web contents manager's work more efficient. Further, since old web contents accumulate despite the use of the conventional technique using the tracking server, it is difficult to make the web contents manager's work more efficient.

Japanese Laid-open Patent Publication Nos. 2005-293251 and 2002-244961 are examples of related art.

### SUMMARY

According to an aspect of the invention, an information processing apparatus includes a contents storage unit that stores contents, the contents being data for conducting a display on a web site, a registration receiving unit that receives registration contents, a determining unit that determines whether the registration contents received by the registration receiving unit matches storing contents previously stored in the contents storage unit, and a registration processing unit that, when the registration contents received by the registration receiving unit match the storing contents previously stored in the contents storage unit, stores either one of the registration contents or the storing contents and erases another contents.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING

FIG. 1 explains an outline of a system for providing web contents;

FIG. 2 is a block diagram of a server according to a first embodiment;

FIG. 3 is an example of contents data;

FIG. 4 is a method of web contents registration processing by the server according to the first embodiment;

FIG. 5 is a block diagram of a server according to a second embodiment;

FIG. 6 illustrates details of information stored by a contents management data storing unit according to the second embodiment;

FIG. 7 illustrates an example of access transition information;

FIG. 8 illustrates an example of change condition information;

FIG. 9 is a view for explaining an outline of an access path change before the change;

FIG. 10 is a view for explaining an outline of an access path change after the change;

FIG. 11 is a method of beacon embedding processing and access path registration processing according to the second embodiment;

FIG. 12 is a method of access analysis processing according to the second embodiment;

FIG. 13 is a method of movement destination contents change processing according to the second embodiment;

FIG. 14 is a block diagram of a server according to a third embodiment;

FIG. 15 is an example of child contents management information;

FIG. 16 illustrates an example of a server hardware configuration.

### DESCRIPTION OF EMBODIMENTS

The following will describe in detail aspects of an information processing apparatus and a contents managing method disclosed herein with reference to the drawings. The information processor apparatus and the contents managing method disclosed herein are not limited to the following embodiments.

### Embodiment 1

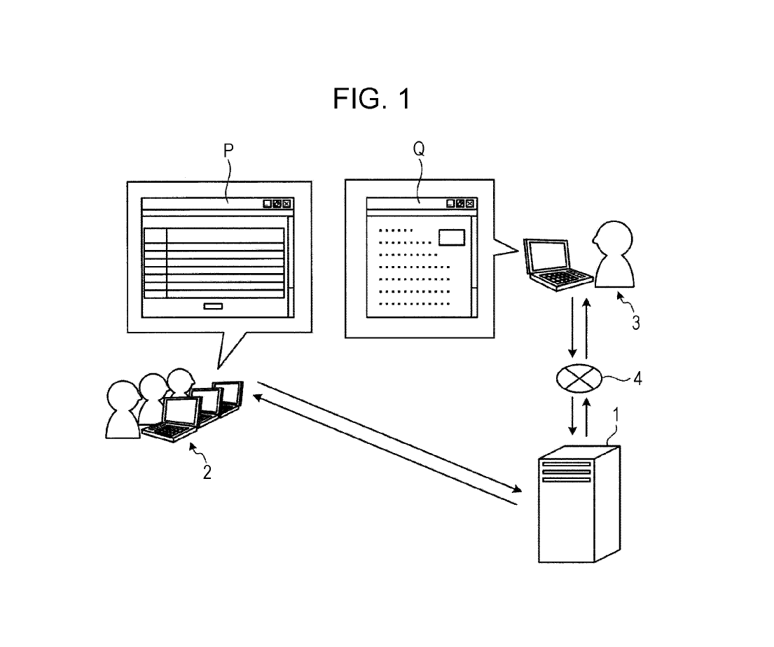

FIG. 1 explains an outline of a system for providing web contents. A system that provides web contents according to the present embodiment includes a server 1, a registrant terminal 2, a user terminal 3, and an internet 4.

The server 1 stores web contents. The web contents herein include web pages, parts used in those pages, and the like. The server 1 transmits the web contents to the user terminal 3 through the internet 4 in response to a request from a user.

A registrant uses, for example, a registration screen P displayed on the registrant terminal 2 to register the web contents on the server 1 to build a web site. The registrant uses, for example, the registration screen P displayed on the registrant terminal 2 to edit the web contents registered in the server 1. The web contents registered in the server 1 are updated based on the editing by the registrant.

The user uses, for example, the user terminal 3 to request the server 1 to display the web contents. The user terminal 3 then displays a web page Q transmitted by the server 1 in response to the user request on a monitor and the like. The user requests movement to another web page by, for example, clicking a link added to the web page Q displayed on the user terminal 3. The user terminal 3 receives from the server 1 the web page in response to the movement request and displays the web page on the monitor and the like. As a result, movement of the web contents is conducted within the web site.

As described above, the registrant registers the web contents in the server 1 and the user reads the web contents registered by the registrant.

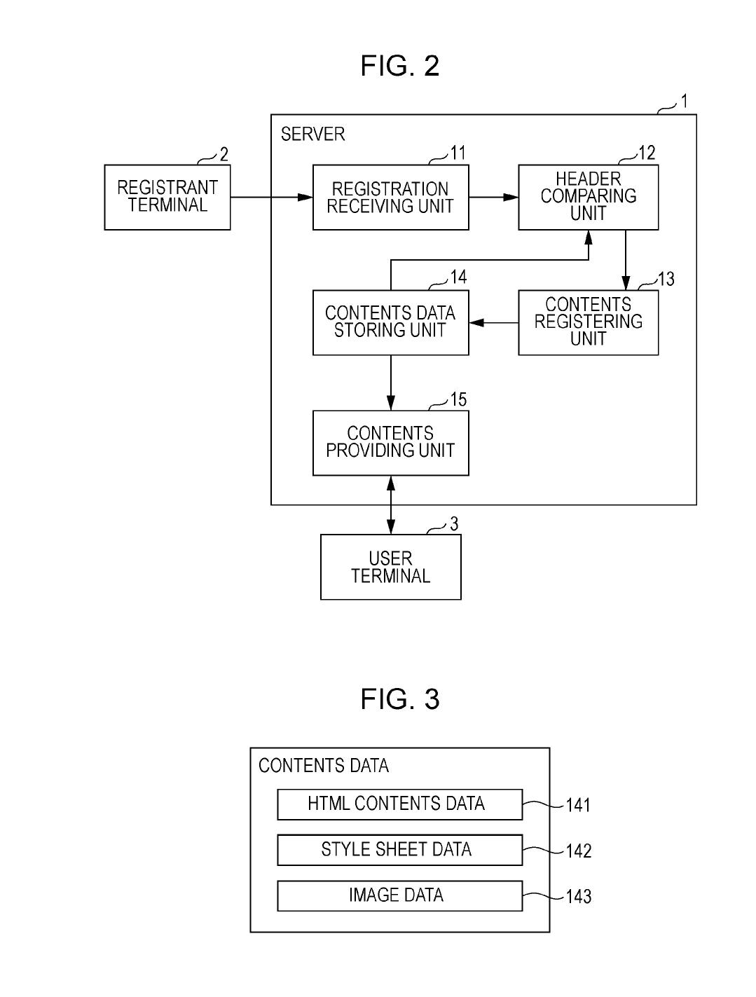

Next, a detailed description of the server 1 according to the present embodiment will be provided with reference to FIG. 2. FIG. 2 is a block diagram of a server according to the first embodiment.

As illustrated in FIG. 2, the server 1 according to the present embodiment includes a registration receiving unit 11, a header comparing unit 12, a contents registering unit 13, a contents data storing unit 14, and a contents providing unit 15.

The contents data storing unit 14 stores contents data for displaying a web page configuration. The contents data includes Hyper Text Markup Language (HTML) contents data 141, style sheet data 142, and image data 143. FIG. 3 illustrates an example of the contents data. The HTML contents data 141 is data that uses HTML to describe the content of a web page. The style sheet data 142 is data including style information such as text size and colors and the like used in the web page. The image data 143 is data of images used in the web page. The contents data storing unit 14 stores the contents data created for each web page. The contents data storing unit 14 is an example of a “contents storage unit.”

The web contents such as the HTML contents data 141, the style sheet data 142, and the image data 143 have file headers. For example, file information such as the file types and the sizes of the web contents is stored in the file headers of the web contents.

The contents providing unit 15 receives a request to display a web page from the user terminal 3. The contents providing unit 15 obtains the web contents that configure the requested web page from the contents data storing unit 14. The contents providing unit 15 then creates the web page using the obtained web contents. Next, the contents providing unit 15 transmits the requested web page to the user terminal 3 to be displayed on a display unit such as a monitor of the user terminal 3.

The registration receiving unit 11 receives the web contents data to be registered and an instruction for registration of the web contents from the registrant terminal 2. The web contents corresponding to the registration instruction received from the registrant terminal 2 by the registration receiving unit 11 is referred to herein below as “registration web contents.” A plurality of web contents that are various types of contents data may be included in the registration web contents. The registration receiving unit 11 outputs the registration web contents to the header comparing unit 12.

The header comparing unit 12 receives the registration web contents input from the registration receiving unit 11. The header comparing unit 12 determines whether the registration web contents are binary files or script files.

If the registration web contents are binary files, the header comparing unit 12 obtains the sizes and file types from the file headers of the registration web contents. The header comparing unit 12 then extracts the web contents that are binary files from the web contents previously registered in the contents data storing unit 14. The header comparing unit 12 obtains the sizes and file types from the file information stored in the headers of the extracted web contents. The header comparing unit 12 then determines whether any of the sizes and file types among the web contents previously registered match the registration web contents. If a size and file type match is found, the header comparing unit 12 determines whether the previously registered web contents with the matching size and file type have the same contents, and then notifies the contents registering unit 13 about the same contents information.

Conversely, if the registration web contents are script data, the header comparing unit 12 extracts the web contents that are script files from the web contents previously registered in the contents data storing unit 14. The header comparing unit 12 then compares the registration web contents with the extracted web contents. If the registration web contents and the extracted web contents match, the header comparing unit 12 determines that the matching previously registered contents is the same contents and then notifies the contents registering unit 13 about the same contents information. A match of the script file web contents signifies, for example, that the script description is the same.

The header comparing unit 12 then transmits the registration web contents data to the contents registering unit 13. The header comparing unit 12 is an example of a “determining unit.”

The contents registering unit 13 receives the registration web contents data from the header comparing unit 12. The contents registering unit 13 also receives an input of the same contents information from the header comparing unit 12 if the same contents are present.

When the same contents information is received, the contents registering unit 13 re-writes the registration web contents to the same contents in the contents data storing unit 14. Web contents with matching sizes and image types are very likely to be the same contents in the case of binary files. As a result, the web contents in binary files received from the registrant may be re-written to previously registered web contents with a matching size and matching image types.

Conversely, if there are no matching contents, the contents registering unit 13 holds the received registration contents as-is.

The contents registering unit 13 then stores the registration web contents to the same contents in the contents data storing unit 14. When the registration web contents are re-written to the same contents, the contents registering unit 13 overwrites the same data of the same web contents. The contents registering unit 13 is an example of a “registration processing unit.”

While the contents registering unit 13 overwrites the same web contents if the same contents are present, the present embodiment is not limited as such and another method that is a method to keep the same contents may be used. For example, when the same contents are present, the contents registering unit 13 or the header comparing unit 12 may erase the registration web contents and conduct processing to keep the same contents.

Further, if the registration web contents include a plurality of web contents, the header comparing unit 12 and the contents registering unit 13 may repeat the above processing one by one on the web contents included in the registration web contents as the registration web contents.

In this way, the contents registering unit 13 erases the registration web contents and keeps the previously registered contents when the registration web contents are present in the previously registered web contents. As a result, the contents registering unit 13 is able to avoid registering the same web contents twice.

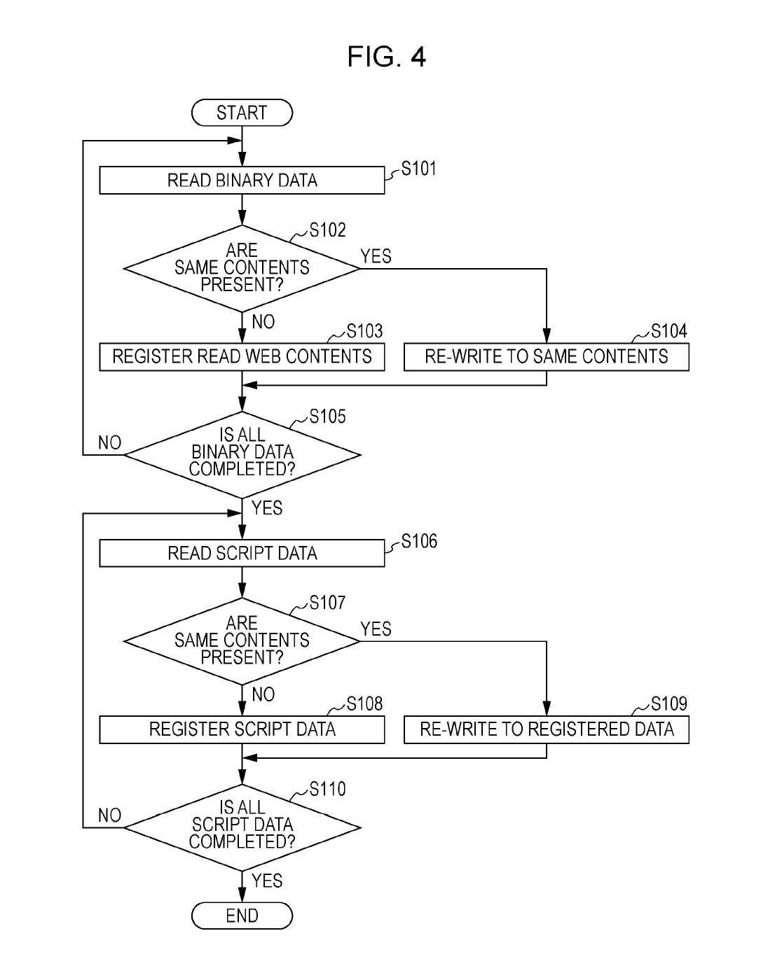

Next, a flow of web contents registration processing by the server 1 according to the present embodiment will be provided with reference to FIG. 4. FIG. 4 is a method of web contents registration processing by the server according to the first embodiment. The flow in FIG. 4 describes a case in which the registration web contents include a plurality of web contents.

The header comparing unit 12 reads the web contents that are binary data among the web contents included in the registration web contents (step S101).

The header comparing unit 12 then searches among the web contents that are binary data in the previously registered web contents for web contents in which the size and file type matches the read web contents, to determine if the same contents are present (step S102).

If no same contents are present (step S102: No), the contents registering unit 13 stores the read web contents in the contents data storing unit 14 and registers the web contents (step S103).

Conversely, if the same contents are present (step S102: Yes), the contents registering unit 13 re-writes the read web contents to the same contents (step S104). The contents registering unit 13 then writes the re-written same contents over the same contents in the contents data storing unit 14.

Next, the header comparing unit 12 determines whether the comparison of all the binary data web contents included in the registration web contents has been completed (step S105). The header comparing unit 12 returns to step S101 if binary data that has not been compared remains (step S105: No).

Conversely, if the comparison of all the binary data has been completed (step S105: Yes), the header comparing unit 12 reads the web contents that are script data among the web contents included in the registration web contents (step S106).

The header comparing unit 12 then searches among the web contents that are script data in the previously registered web contents for web contents that match the read web contents, to determine if the same contents are present (step S107).

If no same contents are present (step S107: No), the contents registering unit 13 stores the read web contents in the contents data storing unit 14 and registers the web contents (step S108).

Conversely, if the same contents are present (step S107: Yes), the contents registering unit 13 re-writes the read web contents to the same contents (step S109). The contents registering unit 13 then writes the re-written same contents over the same contents in the contents data storing unit 14.

Next, the header comparing unit 12 determines whether the comparison of all the script data web contents included in the registration web contents has been completed (step S110). The header comparing unit 12 returns to step S106 if script data that has not been compared remains (step S110: No).

Conversely, if the comparison of all the script data has been completed (step S110: Yes), the header comparing unit 12 and the contents registering unit 13 finish the web contents registration processing.

As described above, the information processor apparatus according to the present embodiment conducts remaining processing only on the previously registered web contents when the same contents as the web contents that received a registration instruction are previously registered. Accordingly, registering web contents twice may be reduced. As a result, the work of the manager may be made more efficient since the work by the manager of the web contents of finding and erasing web contents registered twice is avoided. Since double registration of web contents may be reduced, the use of server removement origins may be reduced and a reduction in server responsiveness may be avoided.

### Embodiment 2

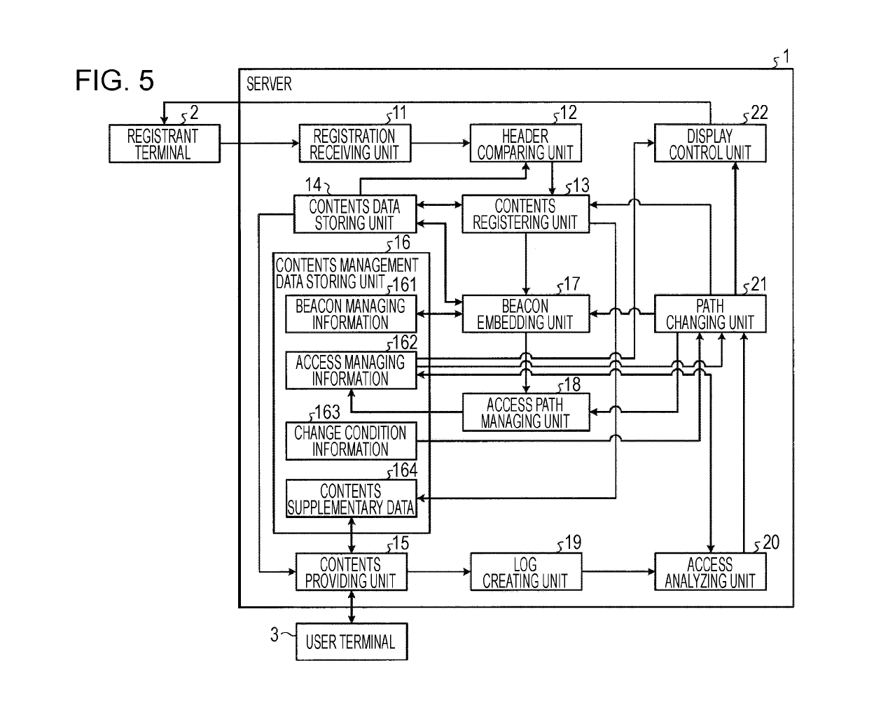

FIG. 5 is a block diagram of a server according to a second embodiment. A server according to the present embodiment differs from that of the first embodiment due to the provision of a function for appropriately changing an access path between web pages. Components that have the same functions those of the first embodiment are omitted in the following explanation.

As illustrated in FIG. 5, the sever 1 according to the present embodiment includes, in addition to the components of the first embodiment, a beacon embedding unit 17, a log creating unit 19, an access analyzing unit 20, and a path changing unit 21. A contents management data storing unit 16 according to the present embodiment stores beacon managing information 161, access managing information 162, change condition information 163, and contents supplementary data 164.

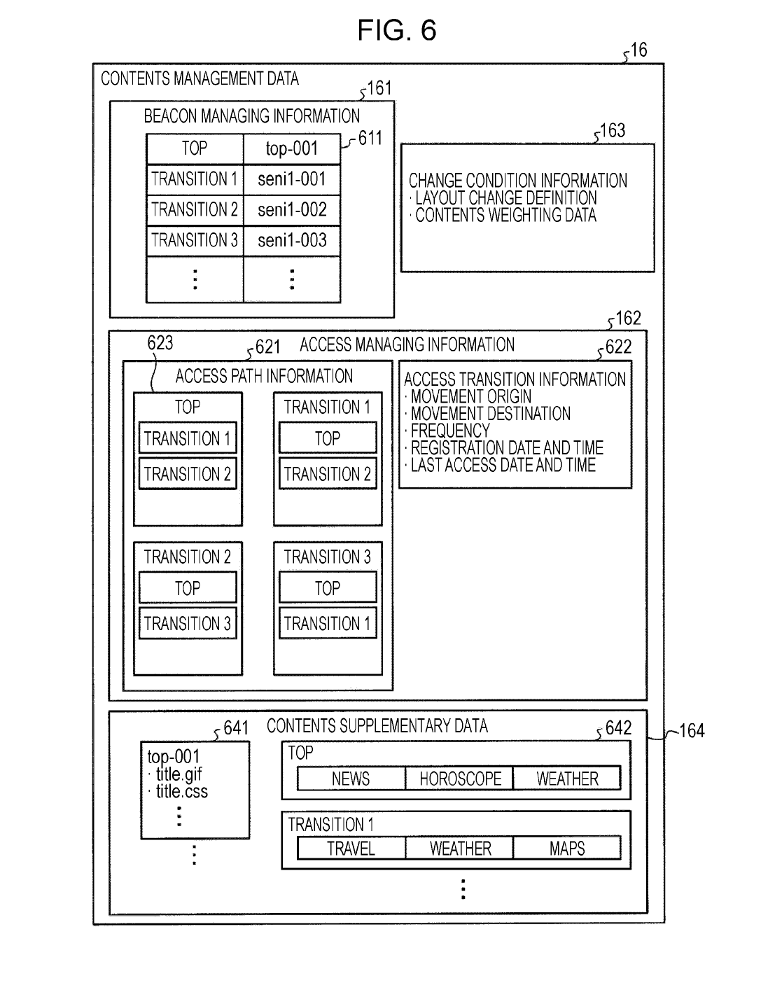

FIG. 6 illustrates details of information stored by a contents management data storing unit according to the second embodiment. Details of the contents management data storing unit 16 will be described herein with reference to FIG. 6.

The beacon managing information 161 includes an ID association table 611 that associates a title of a web page with identification (ID) assigned to that web page. The ID is an ID assigned by the below-mentioned beacon embedding unit. For example, the ID “top-001” is assigned to the top page as the beacon managing information 161 in FIG. 6. Moreover, the ID “seni1-001” is assigned to a transition 1 page, the ID “seni1-002” is assigned to a transition 2 page, and the ID “seni1-003” is assigned to a transition 3 page.

The access managing information 162 includes access path information 621 and access transition information 622 as illustrated in FIG. 6.

The access path information 621 represents a movement destination web page for each web page, in other words, a transition relationship from one web page to another web page. For example, the access path information 621 is information about access paths of top pages. The access path information 621 indicates that a transition 1 page or a transition 2 page is available as a movement destination from the top page. Specifically, the transition 1 page and/or the transition 2 page are arranged as link targets in the top page as a web page. For example, movement to the transition 1 page is made possible by clicking the link to the transition 1 page arranged on the top page with a mouse or the like when the transition relationship represented by the access path information 621 is present. Movement to the transition 2 page is made possible by clicking the link to the transition 2 page arranged on the top page with a mouse or the like. The contents data storing unit 14 that stores the access path information 621 is an example of a “transition relationship storage unit.”

The access transition information 622 includes information about a movement origin web page, information about a movement destination web page, a frequency of the movements, as well as a registration date and time of the movement destination web page, and a date and time of the last access when a movement from one web page to another web page is conducted.

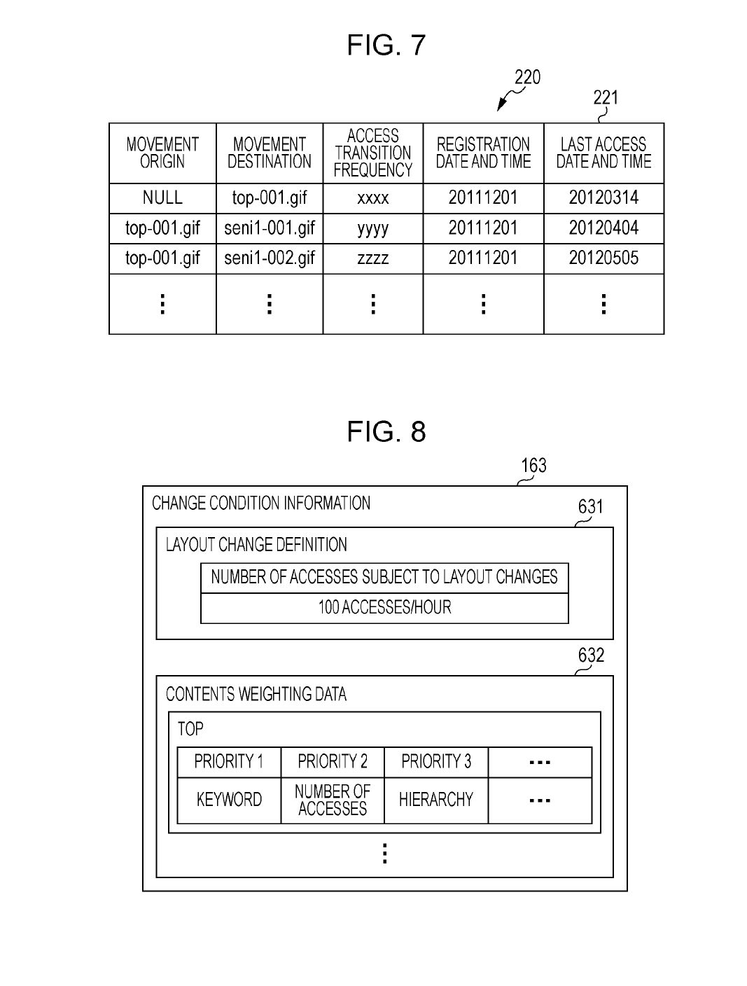

For example, a transition information table 220 is stored as the access transition information 622 as illustrated in FIG. 7. FIG. 7 illustrates an example of access transition information. For example, a row 221 represents a transition relationship of a top page having the ID “top-001” as the movement origin, and a transition 1 page having the ID “seni1-001” as the movement destination. The row 221 indicates that the transition represented by this transition relationship occurred “yyyy” times. Further, the row 221 indicates that the registration date and time of the transition 1 page is Dec. 1, 2011 and the date and time of the last access is Mar. 14, 2012. The contents data storing unit 16 that stores the access transition information 622 is an example of a “movement frequency storage unit.”

The contents supplementary data 164 includes child contents information 641 and keyword data 642. Information about the web contents such as parts used in the web pages is described in the child contents information 641. The web contents such as parts used in the web pages may be referred to as “child contents” herein below. Keywords in the web pages are described in the keyword data 642. In the present embodiment, the contents registering unit 13 registers, for example, the three words with the highest usage frequency among the words written in the web pages as the keywords of the web pages by the keyword data 642. While three keywords are considered in the present embodiment, the number of keywords is not limited as such and any number may be considered.

The change condition information 163 includes a layout change definition and contents weighting data. The layout change definition is information indicating whether a layout change occurs when some type of condition is satisfied. The contents weighting data is information that indicates what type of information is prioritized to conduct a layout change when a layout change is conducted.

The change condition information 163 includes, for example, a layout change definition 631 and contents weighting data 632 as illustrated in FIG. 8. FIG. 8 illustrates an example of change condition information. In the present embodiment, the number of accesses subject to a layout change that is a usage frequency of the transition relationships based on a layout change is used in the conditions for conducting layout changes as indicated by the layout change definition 631. A layout change is considered as conducted when the usage frequency of the transition relationships is 100 or less in one hour. A priority level is set in the order of keywords, number of accesses, and hierarchy when the transition relationship of the top page changes in the present embodiment as indicated by the contents weighting data 632. While three types of information are described as the priority levels in FIG. 8, the information to be used as the priority level is not limited in particular. A method of using the weighting data is explained below.

The beacon embedding unit 17 receives a web contents registration notification from the contents registering unit 13 when a web contents registration occurs. The beacon embedding unit 17 also receives an access path change notification from the path changing unit 21 when a below-mentioned access path change is conducted. When the web contents registration occurs or the below-mentioned access path change is conducted, the beacon embedding unit 17 reads the web contents from the contents data storing unit 14. The beacon embedding unit 17 then determines whether an image beacon is embedded in a web page. If no image beacon is embedded, the beacon embedding unit 17 refers to the beacon managing information 161 and creates an unused ID. The beacon embedding unit 17 then assigns the created ID to the web page in which an image beacon is not embedded. The beacon embedding unit 17 further creates an image beacon having the assigned ID. When the web page in which the image beacon is embedded is accessed from the user terminal 3, the image beacon outputs information about the movement origin web page that the user terminal 3 had accessed before and about the movement destination web page that was accessed. The beacon embedding unit 17 embeds the created image beacon in the web page to which the ID was assigned. The beacon embedding unit 17 then notifies an access path managing unit 18 about the read web contents information. The beacon embedding unit 17 is an example of a “mark embedding unit.”

The access path managing unit 18 receives the notification about the read web contents information from the beacon embedding unit 17. The access path managing unit 18 determines whether access path information of the web contents information read by the beacon embedding unit 17 is registered in the access managing information 162. If the web contents are registered and a notification about an access path change of the web contents is received from the below-mentioned path changing unit 21, the access path managing unit 18 changes the access path information in the access managing information 162. If the web contents are not registered, the access path managing unit 18 registers the access information of the web contents in the access managing information 162.

The log creating unit 19 obtains information about user terminal 3 accesses and information about processing conducted by the contents providing unit 15 from the contents providing unit 15. The log creating unit 19 creates a server application log that includes a history of accesses by the user terminal 3 and a history of processing by the contents providing unit 15. The server application log is a log created through the use of, for example, Apache (trademark).

The access analyzing unit 20 regularly obtains the log created by the log creating unit 19. The access analyzing unit 20 then extracts beacon image information from the obtained log. The access analyzing unit 20 obtains, from the extracted beacon image, information about the movement origin web page ID and the movement destination web page ID. The access analyzing unit 20 converts the obtained information into a format used in a database. For example, the access analyzing unit 20 converts the obtained information to comma separated value (CSV) data. The access analyzing unit 20 increments the access transition frequency by one if a column corresponding to the obtained information is in the access transition information 622 in the access managing information 162. If there is no obtained information in the access transition information 622, the access analyzing unit 20 creates a column corresponding to the obtained information. The access analyzing unit 20 then notifies the path changing unit 21 about the access transition information 622 update. The access analyzing unit 20 is an example of a “transition information obtaining unit.”

The path changing unit 21 receives the notification about the update of the access transition information 622 stored in the access managing information 162 from the access analyzing unit 20. The path changing unit 21 then obtains the access transition frequency of each transition relationship from the access transition information 622 stored in the access managing information 162. The path changing unit 21 then refers to the change condition information 163 to extract the transition relationship that satisfies the change condition determined by the layout change definition (see FIG. 8). Next, the path changing unit 21 selects a new movement origin web page from the transition relationship that satisfies the change condition in accordance with a priority sequence of the contents weighting data 632 (see FIG. 8).

Details of the new movement origin web page selection using the contents weighting data 632 will be explained now. The path changing unit 21 extracts a web page that matches the information with the highest priority level from the web pages other than the current movement origin web page from the transition relationship that satisfies the change condition. When a plurality of web pages are extracted at this time, the path changing unit 21 further extracts a web page that conforms to the next priority level information from the extracted web pages. The path changing unit 21 repeats the extraction work in the order of the highest priority level to determine one web page to select. For example, if the movement origin web page is changed to the top page using the contents weighting data 632 in FIG. 8, the path changing unit 21 obtains the keyword data 642 of each web page in the contents supplementary data 164 (see FIG. 6). The path changing unit 21 then extracts the web page having the same keyword as the top page. When only one web page is extracted at this time, the path changing unit 21 selects the extracted web page as the new movement origin web page. When a plurality of web pages are extracted at this time, the path changing unit 21 selects the web page with the highest number of accesses from the extracted web pages. When a plurality of web pages are extracted at this time, the path changing unit 21 selects the web page with the highest hierarchy from the extracted web pages. In this way, the path changing unit 21 selects a new movement origin web page from the transition relationship that satisfies the change condition.

The path changing unit 21 then changes the movement origin web page of the transition relationship that satisfies the change condition to the selected movement origin web page. Furthermore, the path changing unit 21 notifies the access path managing unit 18 about the change details and the information of the movement origin web page with the changed transition relationship. The path changing unit 21 also notifies the contents registering unit 13 about the information of the changed transition relationship and about the information of the movement origin web page after the change for that transition relationship. The path changing unit 21 then notifies the display controller about the access path change.

The contents registering unit 13 receives the notification about the information of the changed transition relationship and about the information of the movement origin web page after the change for that transition relationship from the path changing unit 21. The contents registering unit 13 fixes the HTML contents data (see FIG. 3) stored in the contents data storing unit 14 and pastes a link to the movement destination web page for the changed transition relationship into the movement origin web page after the change. The contents registering unit 13 erases the link to the movement destination web page for the changed transition relationship on the movement origin web page before the change. The contents registering unit 13 also updates the child contents information of the web page with changed child contents when the child contents of the related web page is changed due to the transition relationship change.

The display control unit 22 receives the notification about the access path change from the path changing unit 21. The display control unit 22 refers to the access path information 621 of the access managing information 162 to obtain information about the access paths between the web pages at that time. The display control unit 22 displays the information about the access paths between the web pages at that time to the registrant terminal 2.

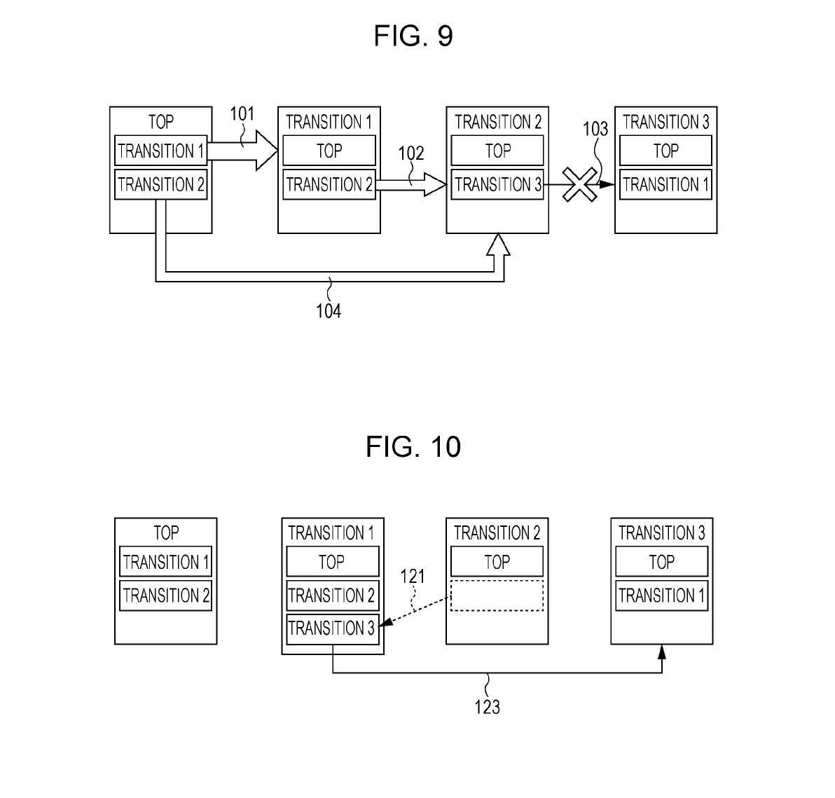

FIG. 9 is a view for explaining an outline of an access path change before a change. FIG. 10 is a view for explaining an outline of an access path change after a change.

Transitions from each web page represented in FIG. 9 are set in a state before a change. Arrows 101 to 105 indicate the access transition frequency between web pages by the size of the arrow. In FIG. 9, the frequency represented by the arrow 101 that is movement from the top page to the transition 1 page is the largest. The frequency represented by the arrow 103 that is movement from the transition 2 page to the transition 3 page is the smallest. In this case, the arrow 103 indicates that the change condition is satisfied. This indicates that the movement origin web page of the arrow 103 is to be changed from the transition 2 page to another web page. The path changing unit 21 then extracts a web page including the same keyword as the transition 3 page keyword if the keyword weighting priority level is the highest. At this time, the path changing unit 21 extracts a web page that matches the next priority level if, for example, the top page and the transition 1 page are extracted. For example, the path changing unit 21 selects the page with the highest access number from the top page and the transition 1 page if the number of accesses is the next highest priority level. The following explains a case in which the number of accesses of the top page is the highest. In this case, the path changing unit 21 makes the transition 2 page the movement origin and changes the movement origin of the transition relationship that makes the transition 3 page the movement destination to the transition 1 page as illustrated in FIG. 10 with the arrow 121. As a result, a link 123 to the transition 3 page is pasted onto the transition 1 page.

For example, the display control unit 22 may display, on the registrant terminal 2, the information illustrated in FIGS. 9 and 10 as the information about the access paths between the web pages.

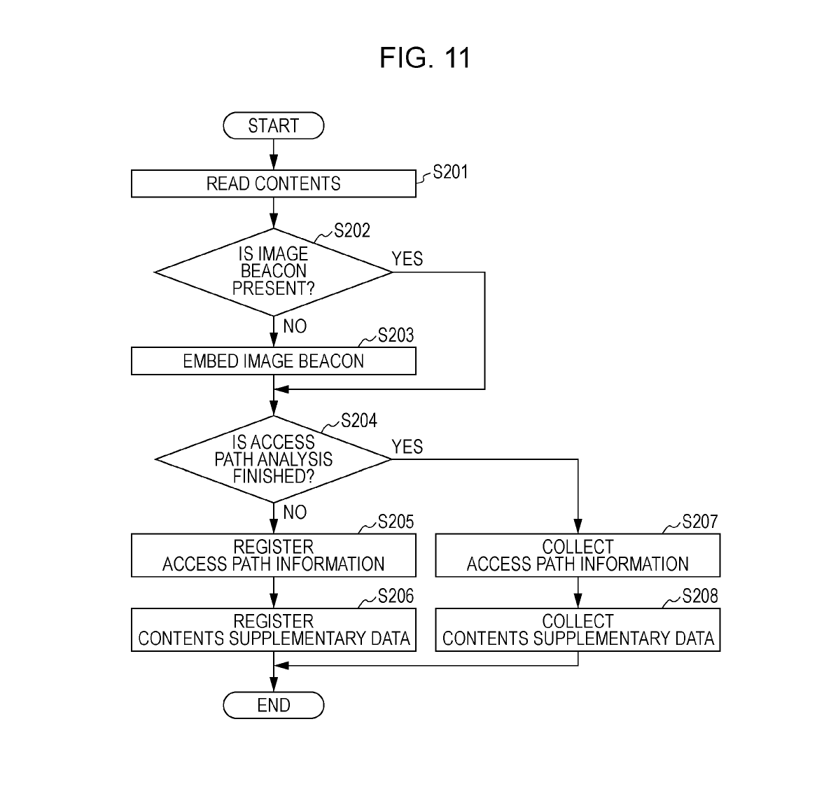

Next, a flow of beacon embedding processing and access path registration processing according to the present embodiment will be provided with reference to FIG. 11. FIG. 11 is a method of beacon embedding processing and access path registration processing according to the second embodiment.

When contents are registered and an access path is changed, the beacon embedding unit 17 obtains contents data from the contents data storing unit 14 and reads the contents (step S201).

The beacon embedding unit 17 then determines whether an image beacon is embedded in the read contents (step S202). If an image beacon is embedded (step S202: Yes), the processing advances to step S204. Conversely, if no image beacon is embedded (step S202: No), the beacon embedding unit 17 embeds an image beacon in the read contents (step S203).

Next, The access path managing unit 18 obtains information about the contents read by the beacon embedding unit 17. The access path managing unit 18 determines whether the access path of the contents of the obtained information is registered in the access managing information 162 (step S204). If the access path is not registered (step S204: No), the access path managing unit 18 registers the access path information of the contents of the obtained information in the access managing information 162 (step S205). The contents registering unit 13 registers the contents supplementary data 164 such as child contents information of contents read by the beacon embedding unit 17 (step S206). The contents registering unit 13 also secures a region for the image ID.

Conversely, if the access path is registered (step S204: Yes), the access path managing unit 18 edits the access path of the contents of the obtained information according to an access path change instruction from the path changing unit 21 (step S207). Further, the contents registering unit 13 edits the contents supplementary data 164 of the contents read by the beacon embedding unit 17 (step S208).

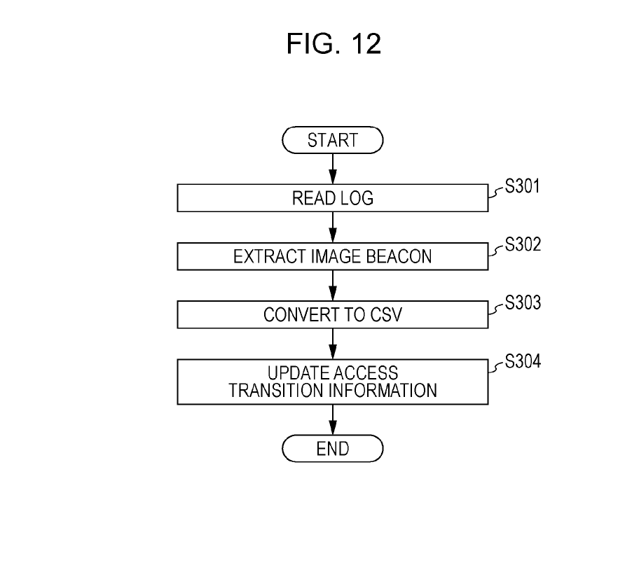

Next, a flow of access analysis processing by the information processor apparatus according to the present embodiment will be provided with reference to FIG. 12. FIG. 12 is a method of access analysis processing according to the second embodiment.

The access analyzing unit 20 obtains the log created by the log creating unit 19 (step S301).

Next, the access analyzing unit 20 extracts an image beacon from the read log (step S302).

Next, the access analyzing unit 20 converts the information of the movement origin web page and the movement destination web page obtained from the image beacon to CSV to create CSV data (step S303).

The access analyzing unit 20 then updates the access transition frequency in the access transition information 622 in the contents management data storing unit 16 (step S304).

While the access transition information 622 is updated each time in the flow in FIG. 12, the present embodiment is not limited as such, and the access analyzing unit 20 may, for example, accumulate CSV data for a certain period of time and then update the access transition information 622 after the certain period of time has passed.

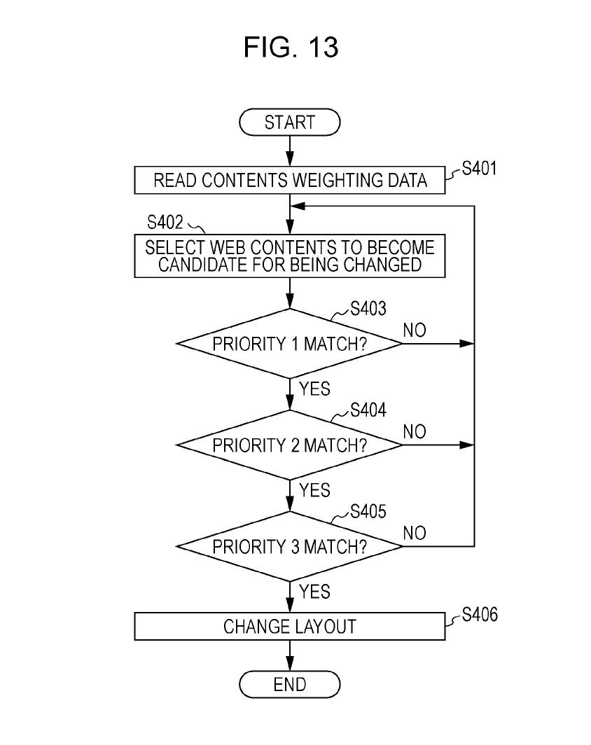

Next, a flow of movement origin contents change processing according to the present embodiment will be provided with reference to FIG. 13. FIG. 13 is a method of movement destination contents change processing according to the second embodiment.

The path changing unit 21 reads the contents weighting data in the change condition information 163 (step S401).

Next, the path changing unit 21 refers to the access path information in the access managing information 162 to select the web contents that is the web contents to be changed as the new movement origin web page (step S402).

The path changing unit 21 then determines whether the selected web contents matches the priority level 1 condition (step S403). If the web contents do not match the priority level 1 condition (step S403: No), the path changing unit 21 returns to step S402.

If the web contents matches the priority level 1 condition (step S403: Yes), the path changing unit 21 determines whether the selected web contents matches the priority level 2 condition (step S404). If the web contents do not match the priority level 2 condition (step S404: No), the path changing unit 21 returns to step S402.

If the web contents matches the priority level 2 condition (step S404: Yes), the path changing unit 21 determines whether the selected web contents matches the priority level 3 condition (step S405). If the web contents do not match the priority level 3 condition (step S405: No), the path changing unit 21 returns to step S402.

If the web contents match the priority level 3 condition (step S405: Yes), the path changing unit 21 selects the web contents that match the priority level 3 condition as the new movement origin web page. The path changing unit 21 updates the access path information 621 in the access managing information 162. Furthermore, the path changing unit 21 transmits the information of the transition relationship in which the movement origin web page is changed and the information about the new movement origin web page to the contents registering unit 13. The contents registering unit 13 then changes the layout of the web page specified as the new movement origin web page (step S406).

As described above, the information processing apparatus according to the present embodiment changes a movement origin web page to become a high access path that has a higher likelihood of being used when the use of an access path from one web page to another web page is low. As a result, the manager of the web contents is able to reduce the tediousness of revising the web site configuration and improve work efficiency. Further, a more suitable access path may be provided to the user and thus usability for the user may be improved.

### Embodiment 3

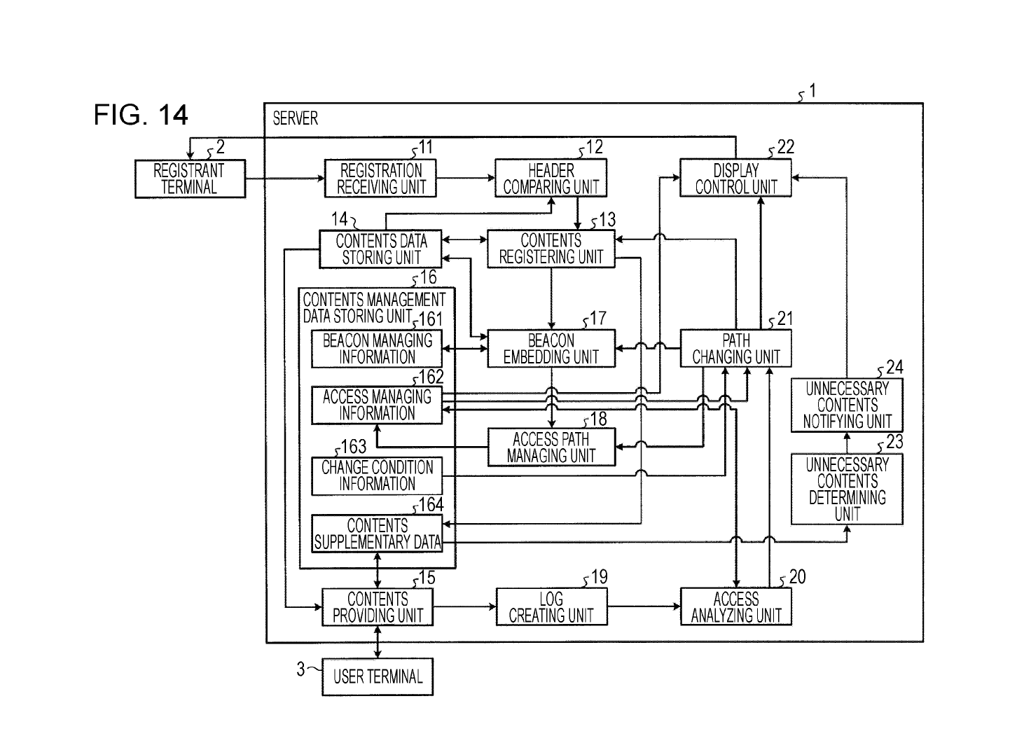

FIG. 14 is a block diagram of a server according to a third embodiment. A server according to the present embodiment differs from that of the first embodiment and the second embodiment in that the server transmits a message recommending the erasing of web contents with a low usage frequency. In the following explanation, explanations of components having the same functions as those of the first embodiment and/or the second embodiment are omitted.

The contents registering unit 13 registers child contents management information representing a usage state of child contents that are web contents used in web pages, in the contents supplementary data 164.

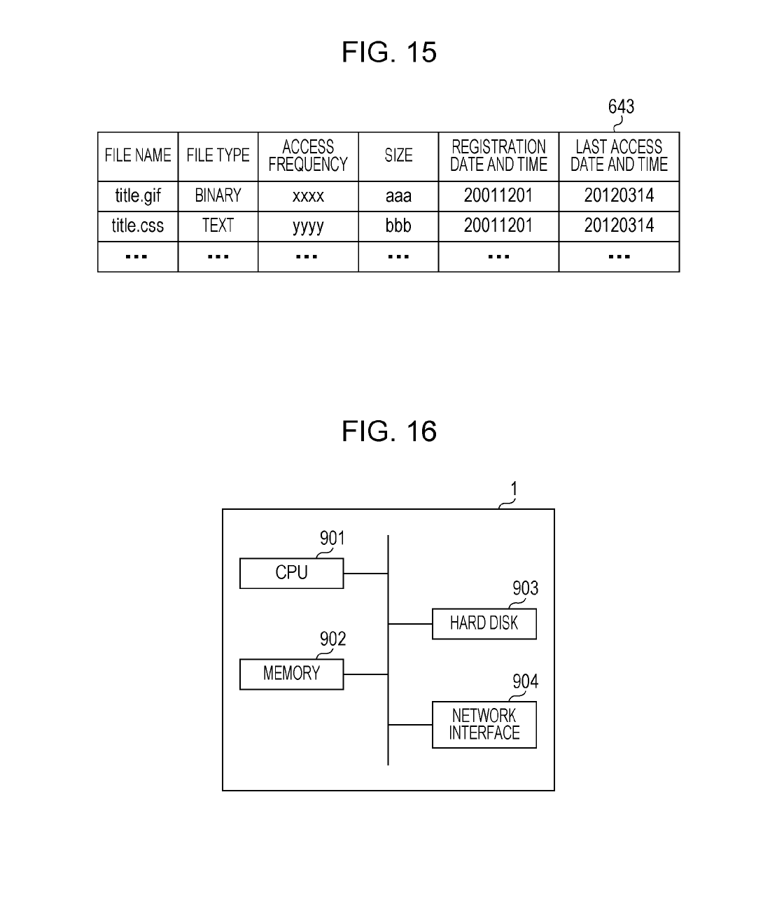

File names of child contents, file type, access frequency, size, registration date and time, and last access date and time are registered for example in the child contents management information. FIG. 15 is an example of child contents management information. For example, the file names of child contents, the file types, the access frequencies, the sizes, registration dates and times, and the last access dates and times may be registered in an associated table as illustrated in a table 643. The contents management data storing unit 16 that stores the child contents management information is an example of an “access data storage unit.”

The contents providing unit 15 increments by one the access frequency in the column of the web page that received an access request in the child contents management information in the contents supplementary data 164 when an access request to the web page is received from the user terminal 3. Further, the contents providing unit 15 updates the last access date and time in the column of the web page that received the access request in the child contents management information, to the date and time that the access request was received. In this way, the contents providing unit 15 updates the child contents management information.

An unnecessary contents determining unit 23 previously stores a determining condition for determining whether child contents are unnecessary contents. For example, in the present embodiment, child contents with an access frequency within a fixed period of time that falls below a threshold and child contents in which the time from the last access exceeds a certain period of time are determined by the unnecessary contents determining unit 23 as unnecessary contents.

The unnecessary contents determining unit 23 obtains the child contents access frequency and the date and time of the last access from the child contents management information in the contents supplementary data 164 every time a predetermined time period has elapsed. The unnecessary contents determining unit 23 then extracts the stored web contents that satisfy the determination condition. Next, the unnecessary contents determining unit 23 transmits the information about the extracted web contents to an unnecessary contents notifying unit 24. The unnecessary contents determining unit 23 is an example of a “detecting unit.”

The unnecessary contents notifying unit 24 instructs the display control unit 22 to transmit to the user a message recommending the erasing of the web contents determined as unnecessary by the unnecessary contents determining unit 23. The unnecessary contents notifying unit 24 is an example of a “notification unit.”

The display control unit 22 receives the instruction to notify the message recommending the erasing of the unnecessary contents and displays the message recommending the erasing of the unnecessary contents on a monitor and the like of the registrant terminal 2.

As described above, the information processor apparatus according to the present embodiment detects web contents with a low access frequency and notifies the manager about erasing the web contents. As a result, the manager of the web contents is able to save the effort of searching for web contents with a low access frequency and is able to improve work efficiency.

An explanation of a hardware configuration of the server 1 according to the above embodiments will be explained with reference to FIG. 16. FIG. 16 illustrates an example of a server hardware configuration.

As illustrated in FIG. 16, the server 1 includes a central processing unit (CPU) 901, a memory 902, a hard disk 903, and a network interface 904.

The memory 902, the hard disk 903, and the network interface 904 are each connected to the CPU 901 with a bus.

The network interface 904 is connected to an external apparatus over a network and sends and receives data with the connected external apparatus.

The hard disk 903 implements, for example, functions of the contents data storing unit 14 illustrated in FIG. 2. The hard disk 903 stores various types of programs such as programs for realizing processing by the registration receiving unit 11, the header comparing unit 12, the contents registering unit 13, and the contents providing unit 15 and the like illustrated in FIG. 2.

The CPU 901 and the memory 902 realize functions such as the registration receiving unit 11, the header comparing unit 12, the contents registering unit 13, and the contents providing unit 15 and the like illustrated in FIG. 2. The CPU 901 reads various programs stored in the hard disk 903 and develops and executes various processes to realize the above functions in the memory 902. The CPU 901 also realizes the functions of sending and receiving data by the registration receiving unit 11 and the contents providing unit 15 by conducting communication between the registrant terminal 2 and the user terminal 3 via the network interface 904.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a contents storage unit that stores contents, the contents being data for conducting a display on a web site;
a registration receiving unit that receives registration contents;
a determining unit that determines whether the registration contents received by the registration receiving unit matches storing contents previously stored in the contents storage unit; and
a registration processing unit that, when the registration contents received by the registration receiving unit match the storing contents previously stored in the contents storage unit, stores either one of the registration contents or the storing contents and erases another contents.

2. The information processing apparatus according to claim 1, wherein the registration processing unit keeps the storing contents stored in the contents storage unit when the registration contents received by the registration receiving unit match the storing contents previously stored in the contents storage unit.

3. The information processing apparatus according to claim 1, further comprising:
a transition relationship storage unit that stores a transition relationship, the transition relationship including information about a combination of movement origin contents and movement destination contents of a movement on the predefined web site between the contents;
a transition information obtaining unit that obtains transition information, the transition information including information about the movement origin contents and the movement destination contents, when a movement from contents displayed on the web site to another contents is conducted according to the transition relationship;
a move frequency storage unit that stores a frequency of movements conducted between the contents based on the transition information; and
a path changing unit that, when the combination of the movement destination contents and the movement origin contents having a frequency of the movements equal to or less than a threshold is present, changes the movement origin contents of the combination in the transition relationship.

4. The information processing apparatus according to claim 3, further comprising:
a display control unit to display the transition relationship on a display unit.

5. The information processing apparatus according to claim 3, further comprising:
a mark embedding unit that embeds in the contents a mark for notifying the transition information obtaining unit about information of the movement origin contents and the movement destination contents when a movement to each of the contents occurs.

6. The information processing apparatus according to claim 1, further comprising:
an access data storage unit that stores a date and time of a movement and a frequency of a movement to each of the contents;
a detecting unit that detects contents for which a first certain time period from a latest date and time stored in the access data storage unit has elapsed, or contents for which the movement frequency in a second certain time period is equal to or less than a certain frequency; and
a notification unit that notifies a recommendation to erase the contents detected by the detecting unit.

7. A method of contents managing executed by a computer, the method comprising:
receiving registration contents that represent data for conducting a display on a web site;
determining whether the registration contents matches storing contents previously stored in a storage unit that stores contents; and
when the registration contents matches the storing contents previously stored in the storage unit, storing either one of the registration contents or the storing contents and erasing another contents.
